(19) United States
(12) Patent Application Publication
(10) Pub. No.: US 2025/0200460 A1
(43) Pub. Date: Jun. 19, 2025

(54) DEVICE USAGE ASSISTANCE APPARATUS, METHOD, AND COMPUTER-READABLE MEDIUM

(71) Applicant: NEC Corporation, Minato-ku, Tokyo (JP)

(72) Inventor: Kazuki OGATA, Tokyo (JP)

(73) Assignee: NEC Corporation, Minato-ku, Tokyo (JP)

(21) Appl. No.: 18/844,516

(22) PCT Filed: Mar. 18, 2022
(86) PCT No.: PCT/JP2022/012799

§ 371 Date: Sep. 6, 2024

(51) Int. Cl. G06Q 10/0631; G06Q 30/0201

(52) U.S. Cl. CPC G06Q 10/06311; G06Q 30/0206

(57) ABSTRACT

Registration means registers recruitment information including information on devices available to a user in a multifunctional pole including one or more devices. Search means searches the recruitment information registered by the registration means, and extracts, in correspondence with a condition specified by a user, a multifunctional pole including a device that meets the condition specified by the user. The presentation means presents the multifunctional pole extracted by the search means to the user.

### TECHNICAL FIELD

The present disclosure relates to a device usage assistance apparatus, a device usage assistance method, and a computer-readable medium.

### BACKGROUND ART

As a related art, Patent Literature 1 discloses a pole to which a device can be attached. The pole disclosed in Patent Literature 1 includes a cylindrical support pillar and one or more coupling poles. The coupling pole includes a cylindrical body. The cylindrical body includes a first connection unit provided at one end thereof in a longitudinal direction, a second connection unit provided at the other end thereof in the longitudinal direction, and a device attachment unit to which a device is attached. The first connection unit of each coupling pole is configured to be connectable to the second connection unit of another coupling pole. A device such as a lighting fixture, a security camera, a speaker, or an automatic flasher is attached to the device attachment unit of each coupling pole. In Patent Literature 1, by increasing or decreasing the number of coupling poles, the length of the poles and the number of devices to be attached can be increased or decreased. In addition, in Patent Literature 1, a function provided by the pole can be changed by replacing the device attached to the coupling pole.

### CITATION LIST

### Patent Literature

Patent Literature 1: Japanese Unexamined Patent Application Publication No. 2019-190002

### SUMMARY OF INVENTION

### Technical Problem

In the future, it is conceivable that more poles such as traffic signals and street lights are replaced by multifunctional poles to which devices such as cameras and sensors are attached. In that case, it is considered that the utility value of the multifunctional pole can be improved if a business operator different from the business operator who has installed the pole can use the functions provided in the multifunctional pole. However, a business operator who desires to use the function needs to check where a multifunctional pole having a desired function is installed and whether the desired function is available in the multifunctional pole. Therefore, a mechanism for assisting the business operator who desires to use functions provided in the multifunctional pole is desired.

In view of the above-described circumstances, an object of the present disclosure is to provide a device usage assistance apparatus, a device usage assistance method, and a computer-readable medium which are capable of assisting usage of functions provided in a multifunctional pole.

### Solution to Problem

In order to achieve the above-described object, the present disclosure provides a device usage assistance apparatus as a first aspect. The device usage assistance apparatus includes: registration means for registering recruitment information including information on a device available to a user in a multifunctional pole including one or more devices; search means for searching the recruitment information and extracting, in correspondence with a condition specified by a user, a multifunctional pole including a device that meets the condition; and presentation means for presenting the extracted multifunctional pole to the user.

The present disclosure provides a device usage assistance method as a second aspect. The device usage assistance method includes: registering recruitment information including information on a device available to a user in a multifunctional pole including one or more devices; searching the recruitment information, and extracting, in correspondence with a condition specified by a user, a multifunctional pole including a device that meets the condition; and presenting the extracted multifunctional pole to the user.

The present disclosure provides a computer-readable medium as a third aspect. The computer-readable medium storing a program for causing a computer to perform processing including: registering recruitment information including information on a device available to a user in a multifunctional pole including one or more devices; searching the recruitment information, and extracting, in correspondence with a condition specified by a user, a multifunctional pole including a device that meets the condition; and presenting the extracted multifunctional pole to the user.

### Advantageous Effects of Invention

The device usage assistance apparatus, the device usage assistance method, and the computer-readable medium according to the present disclosure can assist the usage of the functions included in the multifunctional pole.

### BRIEF DESCRIPTION OF DRAWINGS

FIG. 1 is a block diagram illustrating a schematic configuration of a device usage assistance apparatus according to the present disclosure.

FIG. 2 is a block diagram illustrating a device usage assistance system including a device usage assistance apparatus according to an example embodiment of the present disclosure.

FIG. 3 is an exploded perspective view of a traffic signal that is a multifunctional pole when viewed from an oblique direction.

FIG. 4 is a block diagram illustrating a configuration example of a server.

FIG. 5 is a view illustrating an example of a screen displayed on a user terminal in search.

FIG. 6 is a view illustrating a display example of a search result.

FIG. 7 is a flowchart illustrating an operation procedure of the device usage assistance apparatus.

FIG. 8 is a block diagram illustrating a configuration example of a computer apparatus.

### EXAMPLE EMBODIMENT

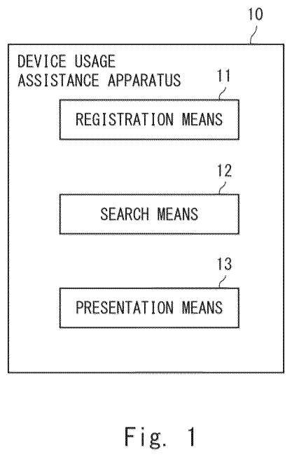

Prior to describing an example embodiment of the present disclosure, an outline of the present disclosure will be described. FIG. 1 illustrates a schematic configuration of a device usage assistance apparatus according to the present disclosure. A device usage assistance apparatus 10 includes registration means 11, search means 12, and presentation means 13.

The registration means 11 registers recruitment information including information on devices available to the user in a multifunctional pole including one or more devices. The search means 12 searches the recruitment information, and extracts a multifunctional pole including a device that meets a condition designated by the user in correspondence with the condition. The presentation means 13 presents the extracted multifunctional pole to the user.

In the present disclosure, for example, in a case where a business operator who installs or manages a multifunctional pole may cause another business operator to use a device or a function provided in the multifunctional pole, the business operator can register recruitment information in the device usage assistance apparatus 10. A user (business operator) who wishes to use a device or a function included in the multifunctional pole can designate a desired condition and request the search means 12 to search for a multifunctional pole that can use the device or the function. The presentation means 13 presents the multifunctional pole searched by the search means 12 to the user. In this manner, the device usage assistance apparatus according to the present disclosure can present the multifunctional pole capable of using the device or the function to the user, and assist the usage of the device or the function of the multifunctional pole.

Hereinafter, example embodiments of the present disclosure will be described in detail with reference to the drawings. Note that, for the clarification of the description, the following descriptions and the drawings are partially omitted and simplified as appropriate. In each drawing, the same elements and the same elements are denoted by the same reference numerals, and repeated description is omitted as necessary.

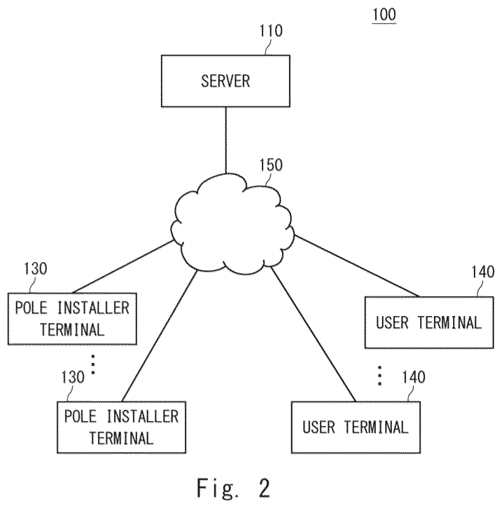

FIG. 2 illustrates a device usage assistance system including a device usage assistance apparatus according to an example embodiment of the present disclosure. A device usage assistance system 100 includes a server 110, one or more pole installer terminals 130, and one or more user terminals 140. The server 110, the one or more pole installer terminals 130, and the one or more user terminals 140 are connected to each other via a network 150 such as the Internet.

Each of the pole installer terminals 130 is a terminal used by a business operator (hereinafter, also referred to as a pole installer) who installs the multifunctional pole or manages the multifunctional pole. Each of the user terminals 140 is a terminal used by a business operator (hereinafter, also referred to as a device usage desiring person or a user) who wishes to use a device or a function provided in the multifunctional pole. The pole installer terminal 130 and the user terminal 140 are configured as information communication devices such as a personal computer (PC), a tablet, and a smartphone.

The multifunctional pole will be described. In the present example embodiment, the multifunctional pole refers to, for example, a pole in which a plurality of devices are installed or incorporated. The multifunctional pole is formed, for example, by connecting a plurality of modules. It is assumed that one or more devices can be incorporated in each module. The modules used for the multifunctional pole may also be referred to as a unit or an assembly (ASSY).

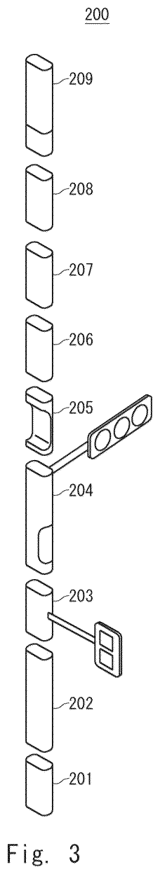

FIG. 3 is an exploded perspective view of a traffic signal 200 that is a multifunctional pole when viewed from an oblique direction. The traffic signal 200 includes a plurality of modules 201 to 209 coupled to each other. Note that, the multifunctional pole is not necessarily configured as a traffic signal, and may be configured as a pole having another function. For example, the multifunctional pole may be a pole for illumination formed by coupling a plurality of modules. The traffic signal 200 may be configured such that additional modules may be inserted at any location.

The module 201 is, for example, a module constituting a common unit. The module 201 internally includes devices such as a power supply apparatus and a network apparatus. The power supply apparatus supplies power to a device mounted on the modules 201 to 209. The network apparatus is connected to an external network. The device mounted on the modules 202 to 209 can be configured to be able to communicate with an external network through the network apparatus of the module 201. For example, but not limited to, the module 201 may be at least partially embedded in the ground. Alternatively, the module 201 may be connected to a foundation disposed on the ground by using a fastening bolt or the like. The module 201 may be coupled to a support pillar embedded in the ground.

The module 202 is, for example, a module having a function of digital signage. The module 202 includes, for example, a display and a control unit (controller). The module 202 may include a speaker and a microphone. Further, the module 202 may include an edge computer (multi-access/mobile edge computing (MEC) server).

The modules 203 and 204 are modules having a function of a traffic signal. The module 203 is a module having a function of a pedestrian traffic signal. The module 204 is a module having a function of a vehicle traffic signal. The module 204 includes a body and a traffic signal lighting device. The traffic signal lighting device has green, yellow, and red lighting devices. An arm of the traffic signal lighting device is attached to the body via an attachment tool. A camera used for controlling the traffic signal lighting device may be built in the body. The module 204 may include a signal lighting control circuit inside the body to control the traffic signal lighting device. The configuration of the module 203 having the function of a pedestrian traffic signal may be similar to the configuration of the module 204 except that the traffic signal lighting device is provided for pedestrians.

The module 205 is a module having a function of a security camera. The module 205 includes, for example, a camera that captures an image of the surroundings and a camera control circuit. The modules 206 and 207 are modules each having a device housing portion to which a device can be attached. A business operator (owner or installer) who installs the traffic signal 200 or a business operator (administrator) who manages the traffic signal 200 can give another business operator the right to use the device housing portions of modules 206 and 207. The other business operator who has acquired the right of use can incorporate a device having a desired function into the traffic signal 200.

The module 208 is a module having a function of a public WiFi (registered trademark) base station. The module 208 includes, for example, a wireless antenna and a WiFi transceiver (wireless communication apparatus). The module 209 is a module having a function of a 5th Generation (5G) antenna base station. The module 209 includes, for example, a wireless antenna and a 5G transceiver (wireless communication apparatus). The communication method of the wireless communication function mounted on the traffic signal 200 is not limited to 5G and public WiFi. The traffic signal 200 may have a module including a wireless communication apparatus of a communication system such as multi-channel access (MCA) advance or cellular vehicle to X (V2X) (C-V2X).

The pole installer uses the pole installer terminal 130 to register, in the server 110, recruitment information for recruiting usage of devices or functions for at least some of the functions provided in the multifunctional pole. In a case where the multifunctional pole includes a device installed by a company other than the pole installer, and in a case where the company permits another company to use the device or the function, the company installing the device can register the recruitment information in the server 110. The recruitment information includes, for example, position information of the multifunctional pole. The recruitment information may include at least one of data, a service, and a computing resource that can be provided by the device to be used.

The recruitment information may include a usage fee for at least one of the data, the service, and the computing resource that are provided. The usage fee may vary depending on time at which the data, the service, or the computer resource is provided, that is, when the data, the service, or the computer resource is provided. For example, the usage fee may vary in correspondence with a time zone. For example, the usage fee may vary in correspondence with a day of the week. For example, the usage fee may vary in correspondence with the season. The usage fee may vary in correspondence with a combination of two or more of the time zone, the day of the week, and the season.

Furthermore, the usage fee may vary depending on a location where the multifunctional pole from which the data, the service, or the computer resource is provided is installed. For example, the usage fee may vary in correspondence with traffic characteristics at a place where the multifunctional pole is installed. For example, in a case where the traffic volume is large, the usage fee may be set higher than that in a case where the traffic volume is small. In addition, the usage fee may be set higher in a time zone with a large traffic volume than in a time zone with a small traffic volume. The usage fee may be set in correspondence with the amount or value of information included in the provided data. The usage fee may be set in correspondence with the number of persons who receive the provided service, the number of terminals, and the degree of importance. The usage fee may be set in correspondence with the performance of a provided computing resource or a demand of a user who desires to use the same computing resource. The usage fee may be a usage fee per day, or may be a usage fee per unit time such as one hour. For example, in a case where data or the like is provided over a certain period such as one day, one week, or one month, an upper limit value of the usage fee may be determined for each period.

In the example of FIG. 3, the traffic signal 200 has functions of a digital signage, a security camera, a WiFi base station, and a 5G antenna base station. The pole installer includes, in the recruitment information, information indicating which function (device) among the functions provided in the traffic signal 200 may be used by other companies. In the traffic signal 200, for example, when the functions of the module 202 (digital signage) and the module 205 (security camera) can be provided to other service providers, the recruitment information includes information indicating that the functions of the signage and the camera can be used.

The user can request the server 110 to search for a multifunctional pole that allows the user to use a desired device or function among multifunctional poles installed in various locations. In the search request, the user can specify, for example, a condition of a place where a multifunctional pole that uses a device or a function is installed. In addition, the user can specify, in the search request, at least one of data, a service, and a computing resource that the user desires to receive from the multifunctional pole. For example, the user can request a search from a webpage provided by the server 110.

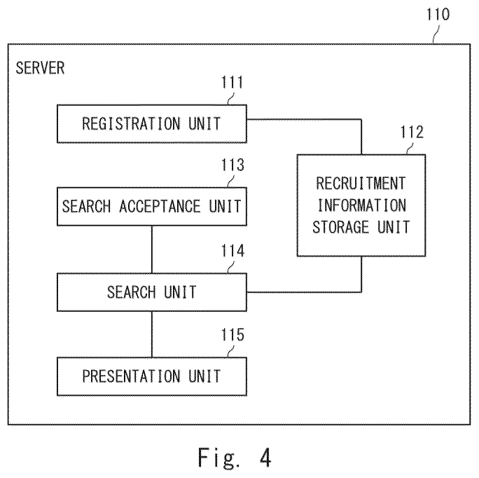

FIG. 4 illustrates a configuration example of the server 110. The server 110 includes a registration unit 111, a recruitment information storage unit 112, a search acceptance unit 113, a search unit 114, and a presentation unit 115. The server 110 includes one or more processors and one or more memories as a physical configuration. At least a part of the function of each unit in the server 110 can be realized by the processor executing processing according to a program read from the memory. In the present example embodiment, the server 110 corresponds to the device usage assistance apparatus 10 illustrated in FIG. 1.

The registration unit 111 receives the recruitment information from the pole installer terminal 130 (refer to FIG. 2). The registration unit 111 stores the recruitment information in the recruitment information storage unit 112. The registration unit 111 corresponds to the registration means 11 illustrated in FIG. 1. Note that, the recruitment information storage unit 112 is not necessarily included in the server 110. The recruitment information storage unit 112 may be configured by using, for example, a storage device connected to the server 110 via a network.

The search acceptance unit 113 accepts the search request transmitted from the user terminal 140. The search unit 114 searches the recruitment information stored in the recruitment information storage unit 112 according to the search request received by the search acceptance unit 113, and extracts one or more multifunctional poles matching the request. For example, the search unit 114 can search the recruitment information and extract a multifunctional pole provided with a device or a function that the user desires to use. For example, in a case where a function desired to be used is specified in the search request, the search unit 114 extracts a multifunctional pole capable of providing the function specified by the user. For example, in a case where the user designates a 4K camera or a sensor such as light detection and ranging (LiDAR) as a function to be used, the search unit 114 extracts a multifunctional pole that can be used by the designated sensor.

For example, in a case where a condition of the installation place of the multifunctional pole is designated, the search unit 114 extracts a multifunctional pole which is provided with a device or a function that the user desires to use and in which position information in the recruitment information meets the designated condition. For example, the user can specify a location of the multifunctional pole and a form of the place a condition of the place. The user designates, for example, conditions such as an urban area, an intersection of two or more lanes on one side, the periphery of an elementary and junior high school, or the coast in the search acceptance unit 113. In this case, the search unit 114 searches the recruitment information, and extracts the multifunctional pole installed at the place meeting the condition. The user can designate a route on which the multifunctional pole is installed as a condition of a place. The user designates, for example, a National Route X or a prefectural road Y. In this case, the search unit 114 searches the recruitment information, and extracts a multifunctional pole that is provided with a device or a function that the user desires to use, and that is installed on the National Route X or the prefectural road Y.

The user may specify characteristics of traffic participants at a location where the multifunctional pole is installed, such as an intersection, as a condition of the place. The user specifies, for example, traffic characteristics such as a large number of two-wheeled vehicles, a large number of pedestrians, or a large amount of traffic on holidays as the condition of the place. The traffic characteristics at the intersection can be obtained from, for example, a database (not illustrated) that stores an analysis result of the traffic characteristics. The search unit 114 searches the recruitment information, and extracts a multifunctional pole that is provided with a device or a function that the user desires to use, and that is installed in a place where the traffic characteristics indicate the designated traffic characteristics.

The user may specify an upper limit value of the usage fee in the search request. In this case, the search unit 114 extracts the multifunctional pole that allows the user to use the device or the function for a fee equal to or less than the amount of money designated by the user. The search unit 114 corresponds to the search means 12 illustrated in FIG. 1.

The presentation unit 115 transmits the information regarding the multifunctional pole extracted by the search unit 114 to the user terminal 140. The user terminal 140 displays the received information of the multifunctional pole on the screen, and presents the user with which multifunctional pole the desired device or function can be used. The user may select, from the presented multifunctional poles, the multifunctional pole on which the user desires to use the device or the function. The user terminal 140 transmits information for identifying the multifunctional pole selected by the user to the presentation unit 115. In a case where the user selects the multifunctional pole on which the user desires to use the device or the function, the presentation unit 115 transmits information on the device or the function that the user desires to use to the pole installer who installs the selected multifunctional pole. The presentation unit 115 corresponds to the presentation means 13 illustrated in FIG. 1.

The pole installer terminal 130 receives information of a device or a function that the user desires to use from the server 110. The pole installer determines whether or not to permit the user to use the device or function. The pole installer causes the user to use the device or the function after completion of the contract or the like. In a case where the device used by the user is a device installed by a company other than the pole installer, availability is determined by the company installing the device.

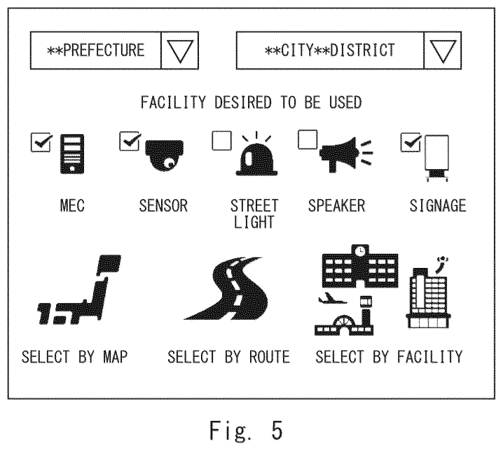

FIG. 5 illustrates an example of a screen displayed on the user terminal 140 in the search. In the example of FIG. 5, the search screen includes an item for specifying a search range, an item for specifying a device desired to be used, and an item for specifying a search method. For example, the search acceptance unit 113 causes the user to designate a prefecture and a municipality on the search screen illustrated in FIG. 5. In addition, the search acceptance unit 113 causes the user to designate a search method. The user designates an area in a somewhat rough range such as a municipality on the search screen, and designates a device desired to be used and a search method.

In the example of FIG. 5, a MEC, a sensor, a street light, a speaker, and a signage are listed as devices (facilities) to be used on the search screen. The user checks a check box of a device to be used. In the example of FIG. 5, the MEC, the sensor, and the signage are designated as devices desired to be used. The search screen may have items for specifying a time zone and a period in which each device is used.

In the example of FIG. 5, the user can designate “select by map”, “select by route”, or “select by facility” as the search method. When the user selects “select by map” on the search screen, the search acceptance unit 113 displays a map of the vicinity of the municipality designated by the user on the display screen of the user terminal 140. The user specifies a geographical range of a place where the user desires to use the device or the function on the displayed map by using a lasso tool or the like. When the user designates the geographical range, the search acceptance unit 113 sets the designated geographical range as the search range. In the recruitment information, the search unit 114 extracts one or more multifunctional poles that have a device designated in a facility to be used and whose position information indicates a position within the search range.

When the user selects “select by route” on the search screen, the search acceptance unit 113 displays a route name of a road or the like in the vicinity of the municipality designated by the user on the display screen of the user terminal 140. The search acceptance unit 113 displays, for example, national roads, prefectural roads, and municipal roads on the display screen of the user terminal 140. The user can designate a route in which the user desires to use the device or the function from the displayed route name. When the user route is designated, the search acceptance unit 113 sets a place along the designated route as the search range. In the recruitment information, the search unit 114 extracts a multifunctional pole including a device designated in a facility desired to be used and indicating a place along a route whose position information is designated.

In a case where the user selects “select by facility” on the search screen, the search acceptance unit 113 displays facility names or facility genres of facilities existing in the vicinity of the municipality designated by the user on the display screen of the user terminal 140. In a case where a genre is selected, the search acceptance unit 113 displays genre names of schools, stations, commercial facilities, and the like. In a case where the user selects the genre name, the search acceptance unit 113 displays the facility name of the facility of the selected genre existing in the vicinity of the municipality designated by the user. The user can designate a facility in which the user desires to use the device or the function from the displayed facility name. In a case where the user designates a facility, the search acceptance unit 113 sets a predetermined range centered on the designated facility as the search range. In the recruitment information, the search unit 114 extracts multifunctional poles that include a device designated in a facility to be used and whose position information indicates a position within the search range.

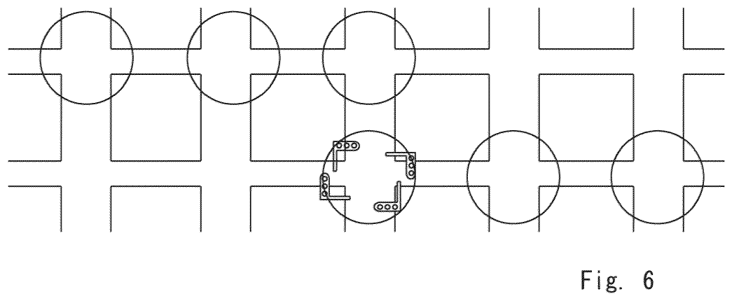

FIG. 6 illustrates a display example of the search result displayed on the user terminal 140 by the presentation unit 115. For example, in a case where a plurality of multifunctional poles is extracted by the search unit 114, the presentation unit 115 groups the multifunctional poles in units of intersections. The user terminal 140 displays an intersection corresponding to each group on the map, and presents the intersection where the multifunctional pole with which the device or the function can be used is installed to the user. In the example of FIG. 6, a circled intersection indicates an intersection at which the extracted multifunctional pole is installed.

The user selects an intersection where the user desires to use the device or the function on the displayed map. In a case where the user selects a desired intersection, the user terminal 140 displays a multifunctional pole installed at the intersection. That is, the user terminal 140 displays the multifunctional pole of the group corresponding to the intersection selected by the user. In the example of FIG. 6, the user terminal 140 displays four multifunctional poles (traffic signals) installed at the intersection selected by the user. The presentation unit 115 causes the user to designate the multifunctional pole in which the user will use the device or the function at the selected intersection. The user can designate one or more multifunctional poles from the four multifunctional poles as multifunctional poles in which the user will use the device or the function. The user may also select a plurality of intersections and designate multifunctional poles installed at the plurality of intersections as multifunctional poles in which the user will use the device or function.

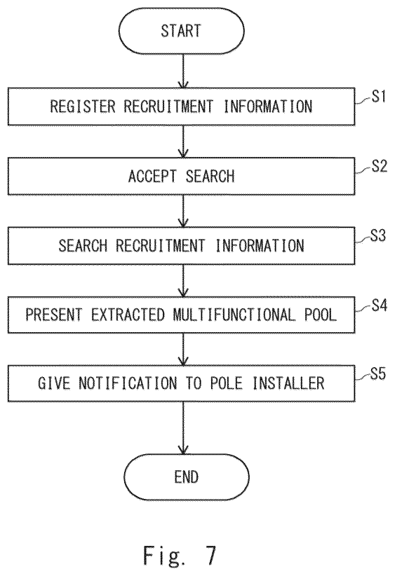

Next, an operation procedure will be described. FIG. 7 illustrates an operation procedure (device usage assistance method) in the server 110. The registration unit 111 receives the recruitment information from the pole installer terminal 130. The registration unit 111 can receive recruitment information for a plurality of multifunctional poles from a plurality of pole installers. The registration unit 111 registers the recruitment information in the recruitment information storage unit 112 (step S1).

The search acceptance unit 113 accepts, from the user terminal 140, a search for a multifunctional pole that allows a user to use a desired device or function (step S2). The search unit 114 searches the recruitment information, and extracts a multifunctional pole provided with a device or a function that the user desires to use (step S3). The presentation unit 115 transmits information for identifying the multifunctional pole extracted in the search in step S3 to the user terminal 140, and presents the extracted multifunctional pole to the user (step S4). The user selects, from the presented multifunctional poles, a multifunctional pole in which the user will use the device or function. In a case where the user selects the multifunctional pole, the presentation unit 115 notifies the pole installer of the selected multifunctional pole of information on the user who desires to use the device or the function (step S5).

For example, in a case where a multifunctional pole is installed as a traffic signal pole, it is considered that the installation company is determined by public recruitment for each intersection, similarly to a normal traffic signal pole. In a case where a business operator different from the business operator having installed the multifunctional pole desires to use the function of the multifunctional pole (multifunctional traffic signal pole), it is necessary to investigate at which intersection the multifunctional pole having what function is installed. In the present example embodiment, the pole installer registers the recruitment information in the server 110, and the device usage desiring person requests the server 110 to search the recruitment information. The server 110 extracts a multifunctional pole provided with a device or a function desired to be used by the device usage desiring person, and presents the extracted multifunctional pole to the device usage desiring person. In the present example embodiment, even in a case where the pole installer is different for each intersection, the server 110 can linearly or planarly extract the multifunctional pole provided with the device or the function that the device user desires to use. The server 110 can perform supply and demand matching between an installation company of a plurality of multifunctional poles and a device usage desiring person who wishes to use the functions of the multifunctional poles installed at a plurality of intersections, and can assist the usage of the devices or functions of the multifunctional poles.

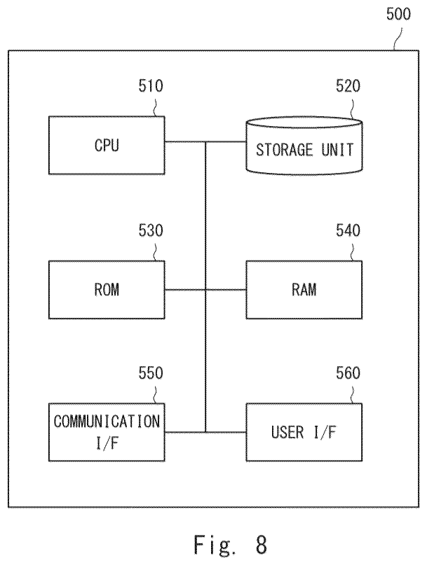

Next, an example of a hardware configuration of the server 110 (device usage assistance apparatus) will be described. FIG. 8 illustrates a configuration example of a computer apparatus that can be used as the server 110. The computer apparatus 500 includes a control unit (central processing unit (CPU)) 510, a storage unit 520, a read only memory (ROM) 530, a random access memory (RAM) 540, a communication interface (interface (IF)) 550, and a user interface 560.

The communication interface 550 is an interface for connecting the computer apparatus 500 to a communication network through wired communication, wireless communication, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 is not necessarily a part of the computer apparatus 500, and may be an external storage device or a cloud storage connected to the computer apparatus 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores, for example, various programs for realizing at least some of the functions of the respective units in the server 110.

The program includes a group of commands (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technique, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. By way of example, and not limitation, transitory computer-readable or communication media include electrical, optical, acoustic, or other forms of propagated signals.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 loads a program stored in the storage unit 520 or the ROM 530 in the RAM 540, and executes the loaded program. The function of each unit in the server 110 can be realized by the CPU 510 executing the programs. The CPU 510 may include an internal buffer in which data or the like can be temporarily stored.

Although the example embodiment according to the present disclosure has been described above in detail, the present disclosure is not limited to the above-described example embodiment, and the present disclosure also includes those that are obtained by making changes or modifications to the above-described example embodiment without departing from the spirit of the present disclosure.

For example, some or all of the above-described example embodiment may be described as the following Supplementary Notes, but the present disclosure is not limited to the following Supplementary Notes.

### Supplementary Note 1

A device usage assistance apparatus including:
registration means for registering recruitment information including information on a device available to a user in a multifunctional pole including one or more devices;
search means for searching the recruitment information and extracting, in correspondence with a condition specified by a user, a multifunctional pole including a device that meets the condition; and
presentation means for presenting the extracted multifunctional pole to the user.

### Supplementary Note 2

The device usage assistance apparatus according to Supplementary Note 1, wherein
the recruitment information includes at least one of data, a service, and a computing resource capable of being provided by the device,
the condition specified by the user includes information specifying at least one of data, a service, and a computing resource that the user desires to receive, and
the search means extracts a device capable of providing at least one of the data, the service, and the computing resource specified by the user as a device that meets the condition.

### Supplementary Note 3

The device usage assistance apparatus according to Supplementary Note 2, wherein
the recruitment information includes a usage fee for at least one of the data, the service, and the computing resource; and
the presentation means further presents the usage fee to the user.

### Supplementary Note 4

The device usage assistance apparatus according to Supplementary Note 3, wherein the usage fee varies in correspondence with time at which at least one of the data, the service, and the computer resource is provided.

### Supplementary Note 5

The device usage assistance apparatus according to Supplementary Note 3 or 4, wherein the usage fee varies in correspondence with a day of the week on which at least one of the data, the service, and the computer resource is provided.

### Supplementary Note 6

The device usage assistance apparatus according to any one of Supplementary Notes 3 to 5, wherein the usage fee varies in correspondence with a season in which at least one of the data, the service, and the computer resource is provided.

### Supplementary Note 7

The device usage assistance apparatus according to any one of Supplementary Notes 3 to 6, wherein the usage fee varies in correspondence with traffic characteristics at a place where the multifunctional pole is installed.

### Supplementary Note 8

The device usage assistance apparatus according to any one of Supplementary Notes 1 to 7, wherein
the recruitment information further includes position information of the multifunctional pole,
the user designates a condition of a place where the multifunctional pole is installed in the search means, and
the search means extracts a multifunctional pole which is provided with a device that meets the condition and in which the position information meets the condition of the place.

### Supplementary Note 9

The device usage assistance apparatus according to Supplementary Note 8, wherein
the user designates a facility as the condition of the place, and
the search means extracts a multifunctional pole which includes a device meeting the condition and in which the position information indicates a position within a predetermined range from the designated facility.

### Supplementary Note 10

The device usage assistance apparatus according to Supplementary Note 8 or 9, wherein
the user designates a route as the condition of the place, and
the search means extracts a multifunctional pole which includes a device meeting the condition and in which the position information indicates a position of the designated route.

### Supplementary Note 11

The device usage assistance apparatus according to any one of Supplementary Notes 8 to 10, wherein
the user designates a geographical range as the condition of the place, and
the search means extracts a multifunctional pole which includes a device meeting the condition and in which the position information indicates a position within the designated geographical range.

### Supplementary Note 12

The device usage assistance apparatus according to any one of Supplementary Notes 8 to 11, wherein
the user designates traffic characteristics as the condition of the place, and
the search means extracts a multifunctional pole which includes a device meeting the condition and in which the position information indicates the designated traffic characteristics.

### Supplementary Note 13

A device usage assistance method including:
registering recruitment information including information on a device available to a user in a multifunctional pole including one or more devices;
searching the recruitment information, and extracting, in correspondence with a condition specified by a user, a multifunctional pole including a device that meets the condition; and
presenting the extracted multifunctional pole to the user.

### Supplementary Note 14

A non-transitory computer-readable medium storing a program for causing a computer to perform processing including:
registering recruitment information including information on a device available to a user in a multifunctional pole including one or more devices;
searching the recruitment information, and extracting, in correspondence with a condition specified by a user, a multifunctional pole including a device that meets the condition; and
presenting the extracted multifunctional pole to the user.

### REFERENCE SIGNS LIST

10 DEVICE USAGE ASSISTANCE APPARATUS
11 REGISTRATION MEANS
12 SEARCH MEANS
13 PRESENTATION MEANS
100 DEVICE USAGE ASSISTANCE SYSTEM
110 SERVER (DEVICE USAGE ASSISTANCE APPARATUS)
111 REGISTRATION UNIT
112 RECRUITMENT INFORMATION STORAGE UNIT
113 SEARCH ACCEPTANCE UNIT
114 SEARCH UNIT
115 PRESENTATION UNIT
130 POLE INSTALLER TERMINAL
140 USER TERMINAL
500 COMPUTER APPARATUS
510 CPU
520 STORAGE UNIT
530 ROM
540 RAM
550 COMMUNICATION I/F
560 USER I/F

What is claimed is:

1. A device usage assistance apparatus comprising:
at least one memory storing instructions; and
at least one processor configured to execute the instructions to:
register recruitment information comprising information on a device available to a user in a multifunctional pole comprising one or more devices;
search the recruitment information and extract, in correspondence with a condition specified by a user, a multifunctional pole comprising a device that meets the condition; and
present the extracted multifunctional pole to the user.

2. The device usage assistance apparatus according to claim 1, wherein
the recruitment information comprises at least one of data, a service, and a computing resource capable of being provided by the device,
the condition specified by the user comprises information specifying at least one of data, a service, and a computing resource that the user desires to receive, and
the at least one processor is configured to execute the instructions to extract a device capable of providing at least one of the data, the service, and the computing resource specified by the user as a device that meets the condition.

3. The device usage assistance apparatus according to claim 2, wherein
the recruitment information comprises a usage fee for at least one of the data, the service, and the computing resource, and
the at least one processor is configured to execute the instructions to present the usage fee to the user.

4. The device usage assistance apparatus according to claim 3, wherein the usage fee varies in correspondence with a time zone in which at least one of the data, the service, and the computer resource is provided.

5. The device usage assistance apparatus according to claim 3, wherein the usage fee varies in correspondence with a day of the week on which at least one of the data, the service, and the computer resource is provided.

6. The device usage assistance apparatus according to claim 3, wherein the usage fee varies in correspondence with a season in which at least one of the data, the service, and the computer resource is provided.

7. The device usage assistance apparatus according to claim 3, wherein the usage fee varies in correspondence with traffic characteristics at a place where the multifunctional pole is installed.

8. The device usage assistance apparatus according to claim 1, wherein
the recruitment information further comprises position information of the multifunctional pole,
the user designates a condition of a place where the multifunctional pole is installed in the search means, and
the at least one processor is configured to execute the instructions to extract a multifunctional pole which comprises a device meeting the condition and in which the position information meets the condition of the place.

9. The device usage assistance apparatus according to claim 8, wherein
the user designates a facility as the condition of the place, and
the at least one processor is configured to execute the instructions to extract a multifunctional pole which comprises a device meeting the condition and in which the position information indicates a position within a predetermined range from the designated facility.

10. The device usage assistance apparatus according to claim 8, wherein
the user designates a route as the condition of the place, and
the at least one processor is configured to execute the instructions to extract a multifunctional pole which comprises a device meeting the condition and in which the position information indicates a position of the designated route.

11. The device usage assistance apparatus according to claim 8, wherein
the user designates a geographical range as the condition of the place, and
the at least one processor is configured to execute the instructions to extract a multifunctional pole which comprises a device meeting the condition and in which the position information indicates a position within the designated geographical range.

12. The device usage assistance apparatus according to claim 8, wherein
the user designates traffic characteristics as the condition of the place, and
the at least one processor is configured to execute the instructions to extract a multifunctional pole which comprises a device meeting the condition and in which the position information indicates the designated traffic characteristics.

13. A device usage assistance method comprising:
registering recruitment information comprising information on a device available to a user in a multifunctional pole comprising one or more devices;
searching the recruitment information, and extracting, in correspondence with a condition specified by a user, a multifunctional pole comprising a device that meets the condition; and
presenting the extracted multifunctional pole to the user.

14. A non-transitory computer-readable medium storing a program for causing a computer to perform processing comprising:
registering recruitment information comprising information on a device available to a user in a multifunctional pole comprising one or more devices;
searching the recruitment information, and extracting, in correspondence with a condition specified by a user, a multifunctional pole comprising a device that meets the condition; and
presenting the extracted multifunctional pole to the user.
